(19) United States
(12) Patent Application Publication
(10) Pub. No.: US 2013/0021007 A1
(43) Pub. Date: Jan. 24, 2013

(54) SWITCHING POWER SOURCE CIRCUIT

(71) Applicant: Akiteru CHIBA, Niiza-shi (JP)

(72) Inventor: Akiteru CHIBA, Niiza-shi (JP)

(73) Assignee: Sanken Electric Co., Ltd., Niiza-shi (JP)

(21) Appl. No.: 13/549,869

(22) Filed: Jul. 16, 2012

(30) Foreign Application Priority Data
Jul. 20, 2011 (JP) 2011-158944

(51) Int. Cl. G05F 1/00

(52) U.S. Cl. 323/265

(57) ABSTRACT

A switching power source circuit includes a first reactor having coils L1-1 and L1-2 connected in series, a second reactor connected in series with the first reactor, a series circuit connected with a DC power source and including the first reactor, the second reactor, a capacitor C1, a diode D1, and an output capacitor, a switching element Q1 connected between a connection point of the coils and the DC power source, a series circuit including a switching element Q2 and a capacitor C2 and connected to a connection point of the coils and to a connection point of the capacitor C1 and diode D1, a reactor L2 connected between a connection point of the capacitor C1 and diode D1 and the DC power source, and a controller controlling ON/OFF of the switching element Q2 so that the switching element Q1 carries out zero-volt switching when turned on.

### BACKGROUND OF THE INVENTION

1. Field of the Invention

The present invention relates to a switching power source circuit capable of reducing a switching loss of switching elements.

2. Description of Related Art

FIG. 1 illustrates a buck-boost switching power source circuit according to a related art. This switching power source circuit is a single-ended primary inductance converter (SEPIC) that employs two reactors to convert an input voltage into a step up or step down output voltage. In FIG. 1, both ends of a DC power source Vin are connected to a series circuit including the reactor L1a, a switching element Q1 of a MOSFET, and a current detecting resistor R1.

Connected between the drain and source of the switching element Q1 is a parallel circuit including a diode Da and a capacitor Ca. The diode Da may be a parasitic diode of the switching element Q1 and the capacitor Ca may be a parasitic capacitor of the switching element Q1.

Both ends of a series circuit including the switching element Q1 and current detecting resistor R1 are connected to a series circuit including a capacitor C1 and the reactor L2. Both ends of the reactor L2 are connected to a series circuit including a diode D1 and an output capacitor Co. According to a voltage from the output capacitor Co and a voltage from the current detecting resistor R1, a controller 100 turns on/off the switching element Q1 to control an output voltage Vo.

The SEPIC switching power source circuit is advantageous in that the DC cutting capacitor C1 inserted in a DC power source line prevents an output short circuit. Another related art of this type is disclosed in, for example, Japanese Unexamined Patent Application Publication No. H08-66017.

### SUMMARY OF THE INVENTION

The related art of FIG. 1 carries out PWM control to superpose a DC current, and therefore, the diode D1 causes a recovery current. Due to the recovery current and a voltage applied to the switching element Q1, the switching element Q1 causes a switching loss to deteriorate the usage efficiency of the DC power source Vin.

The present invention provides a switching power source circuit capable of controlling a voltage not to exceed a withstand voltage of switching elements, realizing zero-volt switching, and improving efficiency.

According to an aspect of the present invention, the switching power source circuit includes a reactor circuit having first and second reactors connected in series, the first reactor having a first coil and a second coil magnetically coupled with the first coil, a first series circuit connected between first and second ends of a DC power source and including the first reactor, the second reactor, a first capacitor, a first diode, and an output capacitor, a first switching element connected between a connection point of the first and second coils and the first end of the DC power source, a second series circuit including a second switching element and a second capacitor, a first end thereof connected to a connection point of the first and second coils and a second end thereof connected to one of a connection point of the first capacitor and first diode and a connection point of the first diode and output, a third reactor connected between a connection point of the first capacitor and first diode and the first end of the DC power source, and a controller controlling ON/OFF of the second switching element so that the first switching element carries out zero-volt switching when turned on.

### BRIEF DESCRIPTION OF THE DRAWINGS

FIG. 1 is a circuit diagram illustrating a buck-boost switching power source circuit according to a related art;

FIG. 2 is a circuit diagram illustrating a switching power source circuit according to Embodiment 1 of the present invention;

FIG. 3 is a waveform diagram illustrating operation at various parts of the switching power source circuit of FIG. 2;

FIGS. 4A to 4D and 5A to 5D illustrate current paths indifferent operation periods of the switching power source circuit of FIG. 2;

FIG. 6 is a circuit diagram illustrating a switching power source circuit according to Embodiment 2 of the present invention;

FIG. 7 is a waveform diagram illustrating operation at various parts of the switching power source circuit of FIG. 6;

FIG. 8 is a circuit diagram illustrating a switching power source circuit according to Embodiment 3 of the present invention;

FIG. 9 is a circuit diagram illustrating a switching power source circuit according to Embodiment 4 of the present invention;

FIG. 10 is a circuit diagram illustrating a switching power source circuit according to Embodiment 5 of the present invention;

FIG. 11 is a circuit diagram illustrating a switching power source circuit according to Embodiment 6 of the present invention; and

FIG. 12 is a circuit diagram illustrating a switching power source circuit according to Embodiment 7 of the present invention.

### DESCRIPTION OF PREFERRED EMBODIMENTS

Switching power source circuits according to embodiments of the present invention will be explained in detail with reference to the drawings.

### Embodiment 1

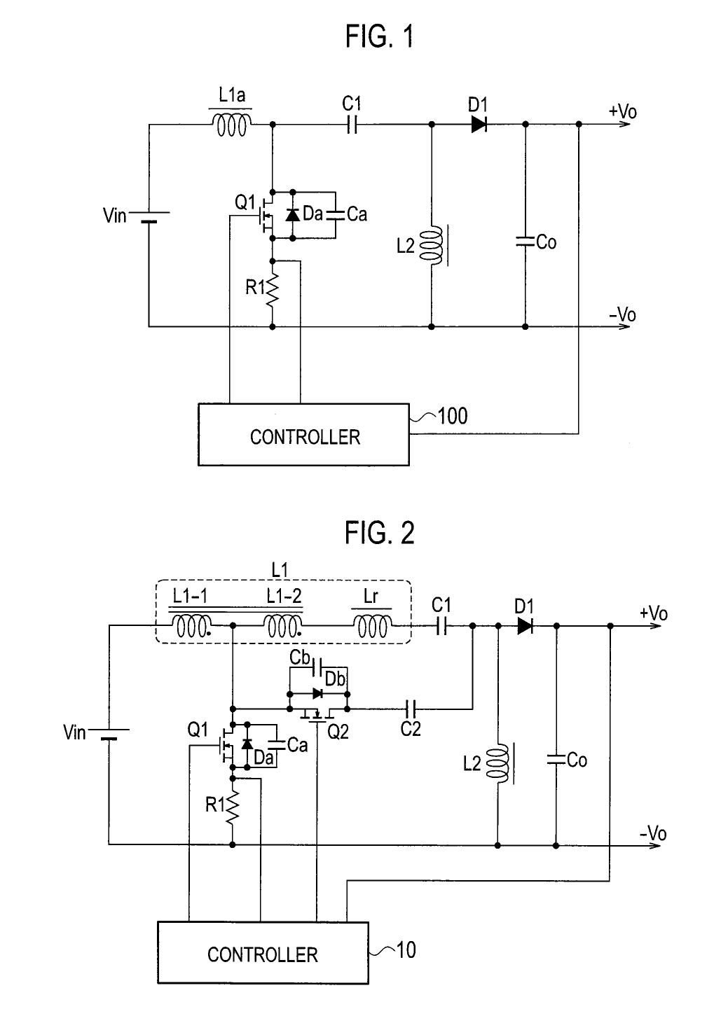

FIG. 2 is a circuit diagram illustrating a switching power source circuit according to Embodiment 1 of the present invention. Compared with the related art of FIG. 1, Embodiment 1 of FIG. 2 employs a reactor L1 (corresponding to the “reactor circuit” in the claims). The reactor L1 includes a first reactor and a second reactor Lr. The first reactor includes a first coil L1-1 and a second coil L1-2 magnetically coupled with the first coil L1-1.

Connected between a connection point of the first and second coils L1-1 and L1-2 and a connection point of a capacitor C1 (corresponding to the “first capacitor” in the claims) and an anode of a diode D1 (corresponding to the “first diode” in the claims) is a series circuit including a switching element Q2 (corresponding to the “second switching element” in the claims) of a MOSFET and a capacitor C2 (corresponding to the “second capacitor” in the claims). The switching element Q2 and capacitor C2 form an active clamp circuit.

Connected between the drain and source of the switching element Q2 is a parallel circuit including a diode Db and a capacitor Cb. The diode Db may be a parasitic diode of the switching element Q2 and the capacitor Cb may be a parasitic capacitor of the switching element Q2.

The remaining configuration of Embodiment 2 is the same as that of the related art of FIG. 1, and therefore, like parts are represented with like reference marks.

The second reactor Lr may be a leakage inductance due to leakage flux between the first and second coils L1-1 and L1-2. Instead of the leakage inductance, the second reactor Lr may be a separate reactor. A turn ratio of the first and second coils L1-1 and L1-2 is, for example, about 10:1. The reactor L2 corresponds to the “third reactor” in the claims.

A controller 10 receives a voltage from an output capacitor Co and a voltage from a current detecting resistor R1, and according to the received voltages, generates a gate signal Q1g, which is applied to the gate of a switching element Q1 (corresponding to the “first switching element” in the claims), to turn on/off the switching element Q1.

In addition, the controller 10 inverts the gate signal Q1g into a gate signal Q2g, which is applied to the gate of the switching element Q2 to turn on/off the switching element Q2.

At this time, the controller 10 controls ON/OFF of the switching element Q2 so that the switching element Q1 carries out zero-volt switching when the switching element Q1 is turned on.

A voltage applied to the switching elements Q1 and Q2 is the sum of a voltage across the output capacitor Co and a voltage across the capacitor C2.

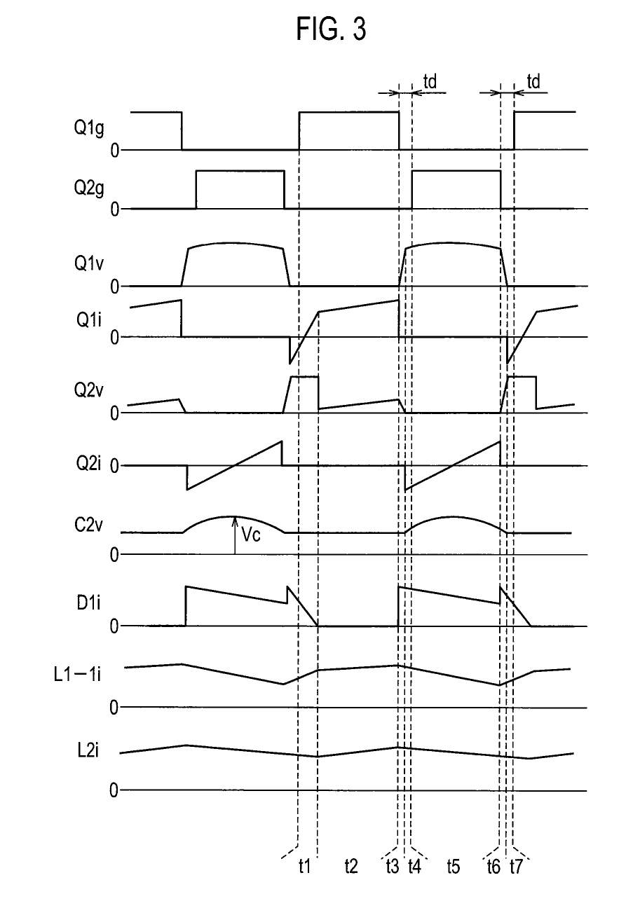

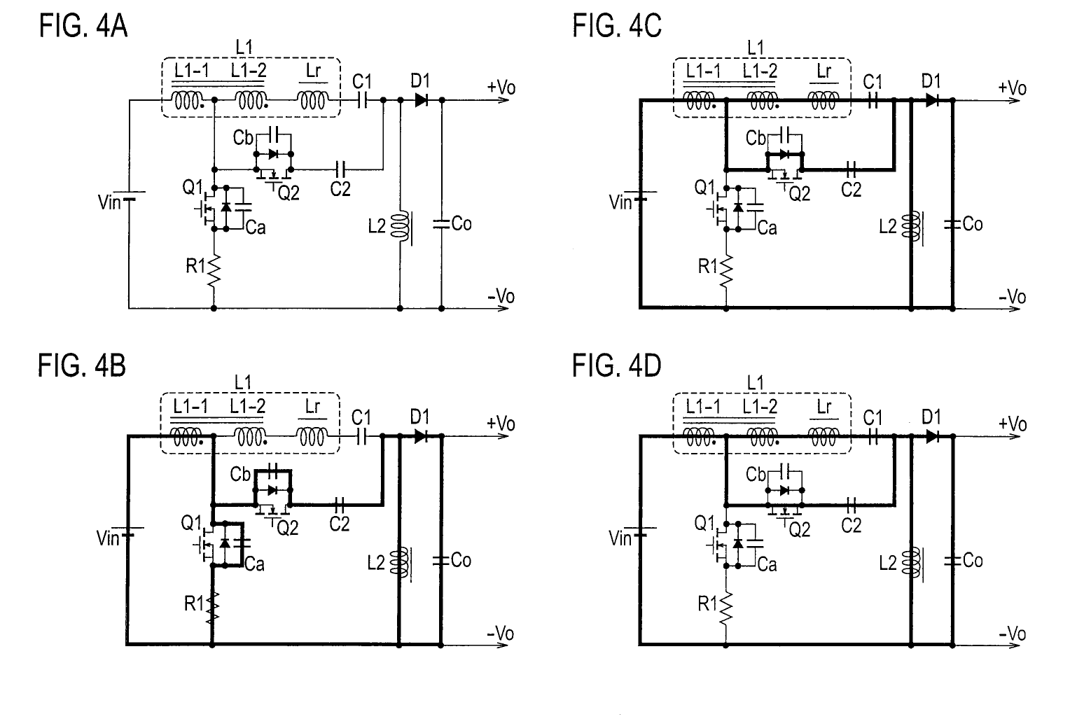

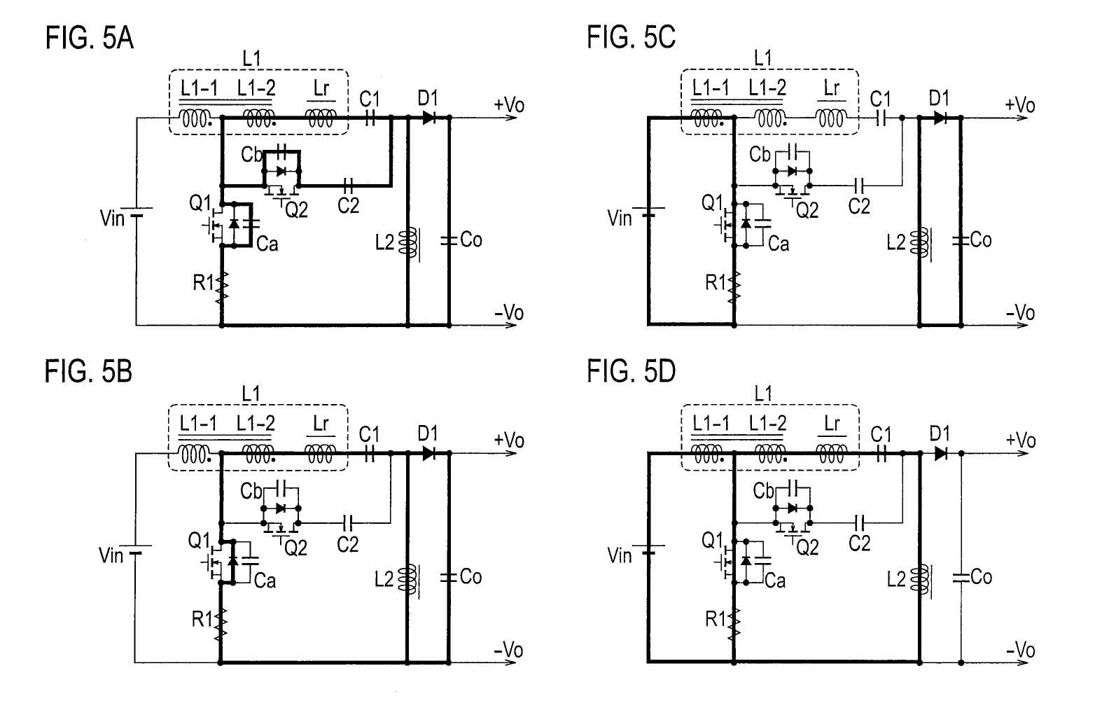

FIG. 3 is a waveform diagram illustrating operation at various parts of the switching power source circuit according to Embodiment 1 and FIGS. 4A to 4D and 5A to 5D illustrate current paths in different operation periods of the switching power source circuit of Embodiment 1.

In FIG. 3, a voltage C2v of the capacitor C2 is defined with a potential on the drain side of the switching element Q2 being positive and a potential on the +Vo side being zero.

Operation of the switching power source circuit according to Embodiment 1 will be explained with reference to FIGS. 2 to 5D. The switching elements Q1 and Q2 are alternately turned on/off with a predetermined dead time td. FIG. 4A illustrates an initial state.

In period t3 of FIGS. 3 and 4B, a voltage of the DC power source Vin excites the reactor L1 and energy of the reactor L1 causes a current passing clockwise through a path extending along L1-1, Q1 (Ca), R1, and a negative electrode of Vin. This current charges the capacitor Ca between the drain and source of the switching element Q1, to increase a drain-source voltage Q1v of the switching element Q1.

At the same time, the energy of the reactor L1 causes a current passing through a path extending along L1-1, Q2 (Cb), C2, D1, Co, and the negative electrode of Vin. As a result, a drain-source voltage Q2v of the switching element Q2 starts to decrease. A voltage change rate dv/dt of the capacitor Ca (Cb) changes according to an inclination determined by a time constant of the first coil L1-1 and capacitor Ca (Cb). At this time, the reactor L2, which has been excited by the switching element Q1 through the capacitor C1, second reactor Lr, and second coil L1-2, starts to discharge energy.

In a period t4 of FIGS. 3 and 4C, energy of the first coil L1-1 starts to discharge to the diode Db of the switching element Q2. A negative current Q2i illustrated in FIG. 3 is the current passing through the diode Db. During the period in which the negative current Q2i passes, the switching element Q2 is turned on with the gate signal Q2g, to realize zero-volt switching of the switching element Q2.

Energy is also discharged to the output capacitor Co through a first path extending along a positive electrode of Vin, L1-1, L1-2, Lr, C1, D1, Co, and the negative electrode of Vin, a second path extending along the positive electrode of Vin, L1-1, Q2, C2, D1, Co, and the negative electrode of Vin, and a third path extending along L2, D1, Co, and L2.

In a period t5 of FIGS. 3 and 4D, the switching element Q1 is OFF and the switching element Q2 is ON. At this time, energy of the reactor L1 charges the capacitor C2 through the switching element Q2. At the same time, energy of the second coil L1-2 starts to discharge, to cause a current passing clockwise through a path extending along L1-2, Lr, C1, C2, Q2, and L1-2, thereby discharging the capacitor C2.

The diode D1 is connected to the second coil L1-2 and second reactor Lr, and therefore, energy discharged from the second coil L1-2 excites the second reactor Lr and is supplied to the capacitor C1. As the charge voltage C2v of the capacitor C2 increases, the capacitor C2 discharges to start clockwise passing a current through a path extending along C2, Q2, L1-2, Lr, C1, and C2. This is understood from that the polarity of the current Q2i of the switching element Q2 positively inverts in the period t5.

In a period t6 of FIGS. 3 and 5A, the switching element Q2 is turned off with the gate signal Q2g and the second reactor Lr starts to discharge excited energy. A current clockwise passes through a path extending along Lr, C1, D1, Co, R1, Ca, L1-2, and Lr. The capacitor Cb is gradually charged at an inclination of dv/dt determined by a time constant of the second reactor Lr and capacitor Ca, to increase the voltage of the capacitor Cb, i.e., the drain-source voltage Q2v of the switching element Q2.

Also, a current clockwise passes through a path extending along Lr, C1, C2, Cb, L1-2, and Lr and excited energy of the second reactor Lr starts to discharge. At this time, the capacitor Ca of the switching element Q1 is discharged and the voltage Q1v of the switching element Q1 decreases.

In a period t7 of FIGS. 3 and 5B, currents pass through the same paths as those in the period t6, and therefore, energy discharged from the second reactor Lr passes through the diode Da of the switching element Q1. A negative current Q1i illustrated in FIG. 3 is the current passing through the diode Da. During the period in which the negative current Q1i causes, the switching element Q1 is turned on with the gate signal Q1g, to realize zero-volt switching of the switching element Q1.

In a period t1 of FIGS. 3 and 5C, the switching element Q1 is turned on to cause a differential current between an excitation current from the DC power source Vin to the first coil L1-1 and a current generated by energy discharged from the second reactor Lr.

In a period t2 of FIGS. 3 and 5D, the energy discharge of the second reactor Lr completes and the current Q1i of the switching element Q1 causes at an inclination of a current excited by the DC power source Vin. At this time, the reactor L2 is excited by the capacitor C1 through the switching element Q1.

In this way, the switching power source circuit according to the present embodiment turns off the switching element Q1 to discharge energy of the excited reactor L1 through the first coil L1-1, switching element Q2, and capacitor C2 to the output capacitor Co or a load. Although the capacitor C2 is charged, energy is also discharged from the second coil L1-2 to discharge the capacitor C2 through a path extending along the second coil L1-2, second reactor Lr, capacitor C1, capacitor C2, and switching element Q2.

As a result, the charge voltage of the capacitor C2 is suppressed to a low level and the drain-source voltage Vds of each of the switching elements Q1 and Q2 never exceeds a withstand voltage of the switching elements Q1 and Q2. Embodiment 1 arranges the second coil L1-2 to actively discharge the capacitor C2 so that the switching elements Q1 and Q2 may not receive a voltage exceeding the withstand voltage of the switching elements Q1 and Q2.

The present embodiment realizes zero-voltage switching of the switching elements Q1 and Q2, to improve the efficiency of the switching power source circuit.

Increasing the number of turns of the second coil L1-2 results in decreasing the voltage C2v of the capacitor C2 even to negative values. In this case, the voltages Q1v and Q2v of the switching elements Q1 and Q2 may decrease lower than an output voltage (the voltage of the output capacitor Co). The DC cutting capacitor C1 is normally charged to a voltage as a summation of DC power source voltage Vin and output voltage Vo and this voltage becomes the withstand voltage of the switching elements Q1 and Q2.

### Embodiment 2

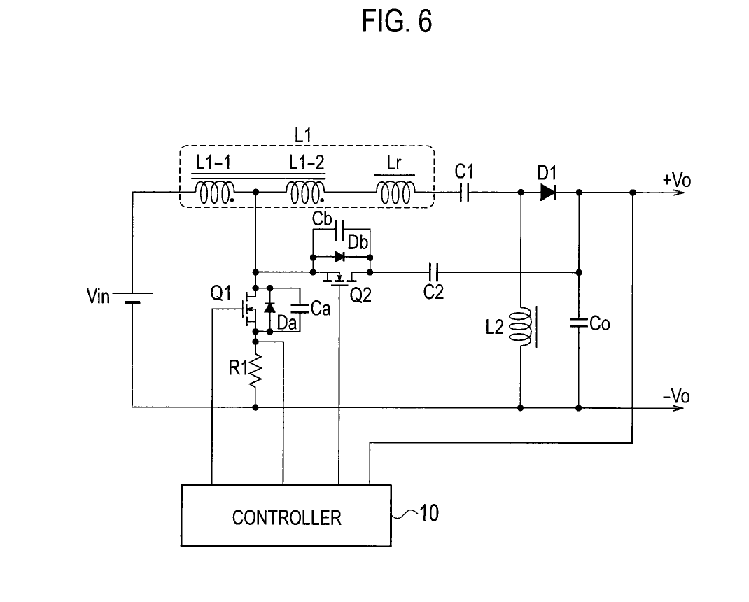

FIG. 6 is a circuit diagram illustrating a switching power source circuit according to Embodiment 2 of the present invention. Embodiment 2 connects a second coil L1-2, a second reactor Lr, a capacitor C1, a diode D1, a capacitor C2, and a switching element Q2 into a closed circuit.

The capacitor C2 of Embodiment 2 of FIG. 6 is differently connected from the capacitor C2 of Embodiment 1 of FIG. 2. The remaining configuration of Embodiment 2 is the same as that of Embodiment 1, and therefore, like parts are represented with like reference marks.

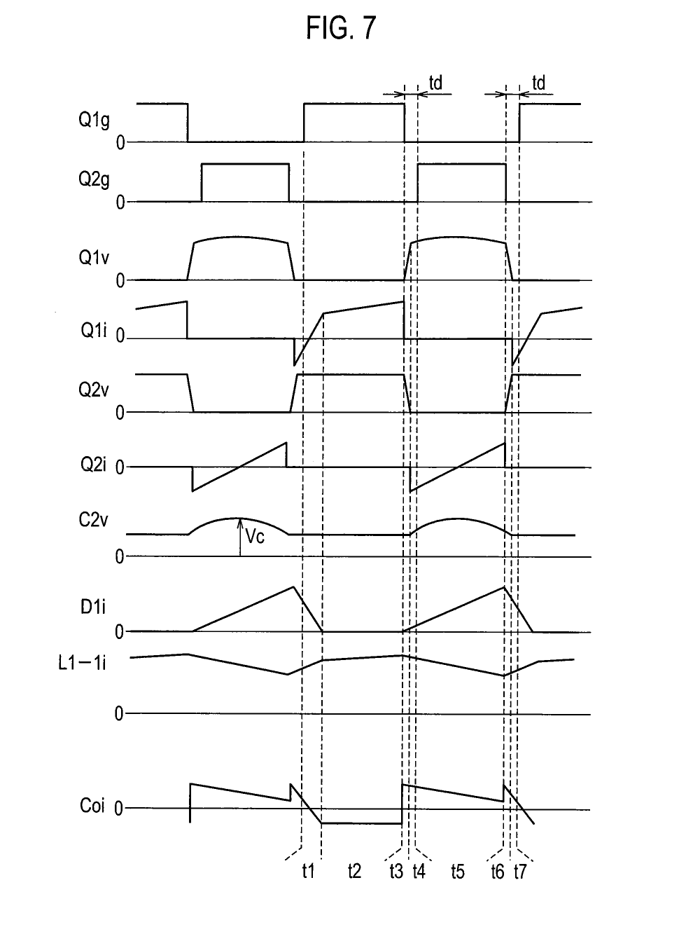

Operation and effects of the switching power source circuit according to Embodiment 2 are similar to those of the switching power source circuit according to Embodiment 1. FIG. 7 is a waveform diagram illustrating operation at various parts of the switching power source circuit according to Embodiment 2.

### Embodiment 3

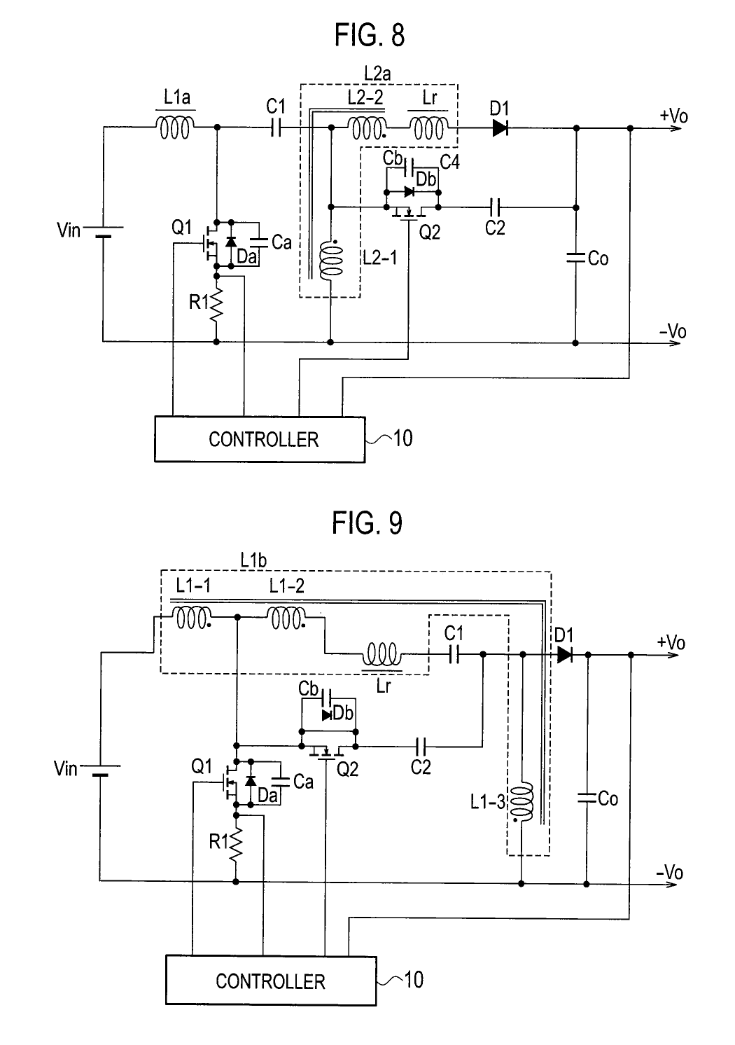

FIG. 8 is a circuit diagram illustrating a switching power source circuit according to Embodiment 3 of the present invention. Embodiment 1 of FIG. 2 that arranges the reactor L1 including the first reactor, which has the first coil L1-1 and the second coil L1-2 magnetically coupled with the first coil L1-1, and the second reactor Lr on the input side (DC power source Vin side) of the capacitor C1. Embodiment 3 of FIG. 8 arranges a reactor (reactor circuit) L2a including a first reactor, which has a first coil L2-1 and a second coil L2-2 magnetically coupled with the first coil L2-1, and a second reactor Lr on the output side of a capacitor C1.

According to the present embodiment of FIG. 8, both ends of a DC power source Vin are connected to a series circuit including a reactor L1a (corresponding to the “third reactor” in the claims), the capacitor C1, the second coil L2-2, the second reactor Lr, a diode D1, and an output capacitor Co. Connected between a connection point of the reactor L1a and output capacitor C1 and a negative electrode of the DC power source Vin is a series circuit including a switching element Q1 and a current detecting resistor R1.

Connected between a connection point of the first and second coils L2-1 and L2-2 and a connection point of the diode D1 and output capacitor Co is a series circuit including a switching element Q2 and a capacitor C2.

The remaining configuration of Embodiment 3 is the same as that of Embodiment 1 illustrated in FIG. 2, and therefore, like parts are represented with like reference marks.

Operation and effects of the switching power source circuit according to Embodiment 3 are similar to those of the switching power source circuit according to Embodiment 1.

### Embodiment 4

FIG. 9 is a circuit diagram illustrating a switching power source circuit according to Embodiment 4 of the present invention. Unlike the switching power source circuit according to Embodiment 1 illustrated in FIG. 2 that employs the reactors L1 and L2, the switching power source circuit according to Embodiment 4 illustrated in FIG. 9 employs a reactor (reactor circuit) L1b that includes a first coil L1-1, a second coil L1-2, and a third coil L1-3 that are magnetically coupled with one another. The third coil L1-3 corresponds to the reactor L2 of FIG. 2.

The switching power source circuit according to Embodiment 4 employing the reactor L1b in which the first, second, and third coils L1-1, L1-2, and L1-3 are magnetically coupled with one another is capable of reducing the number of parts less than the switching power source circuit according to Embodiment 1 illustrated in FIG. 2.

### Embodiment 5

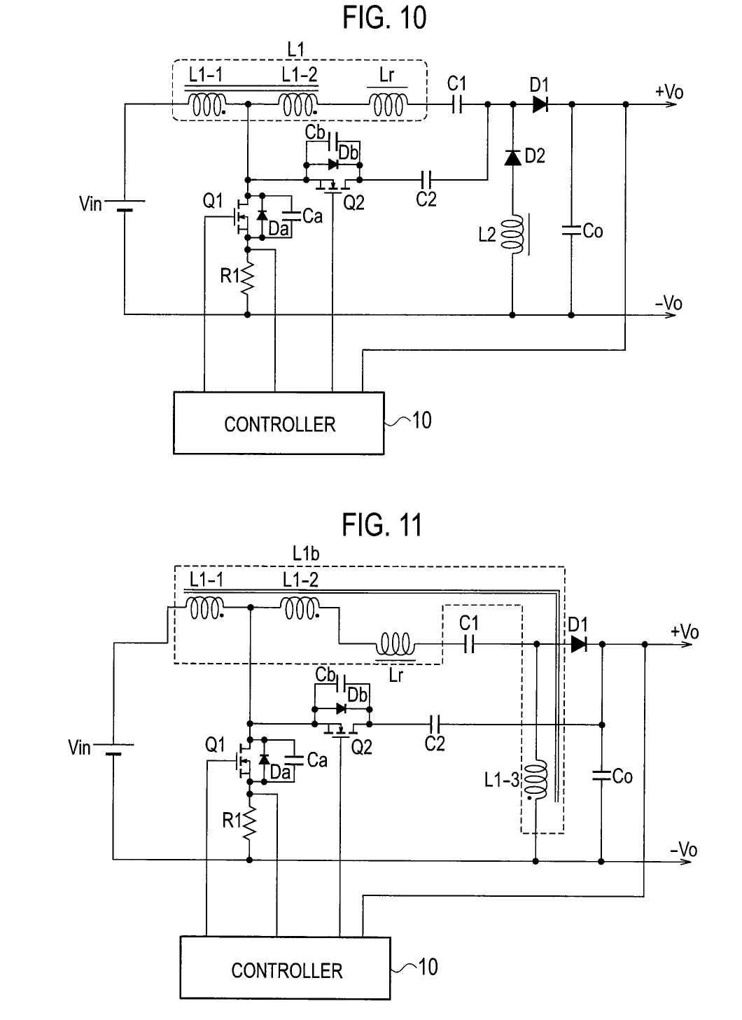

FIG. 10 is a circuit diagram illustrating a switching power source circuit according to Embodiment 5 of the present invention. Compared with the switching power source circuit according to Embodiment 1 illustrated in FIG. 2, the switching power source circuit according to Embodiment 5 additionally employs a diode D2 (corresponding to the “second diode” in the claims). A cathode of the diode D2 is connected to a connection point between a capacitor C1 and an anode of a diode D1 and an anode of the diode D2 is connected to a first end of a reactor L2.

According to Embodiment 5 of FIG. 10, the diode D2 is connected in series with the reactor L2 so that the diode D2 is reversely biased if the capacitor C1 causes a short circuit. This configuration prevents a ground fault (power source short circuit) through a route along Vin, L1, and L2.

### Embodiment 6

FIG. 11 is a circuit diagram illustrating a switching power source circuit according to Embodiment 6 of the present invention. Compared with the switching power source circuit according to Embodiment 4 illustrated in FIG. 9, Embodiment 6 connects a first end of a capacitor C2 to a connection point between a diode D1 and an output capacitor Co.

Operation and effects of the switching power source circuit according to Embodiment 6 are similar to those of the switching power source circuit according to Embodiment 4 illustrated in FIG. 9.

### Embodiment 7

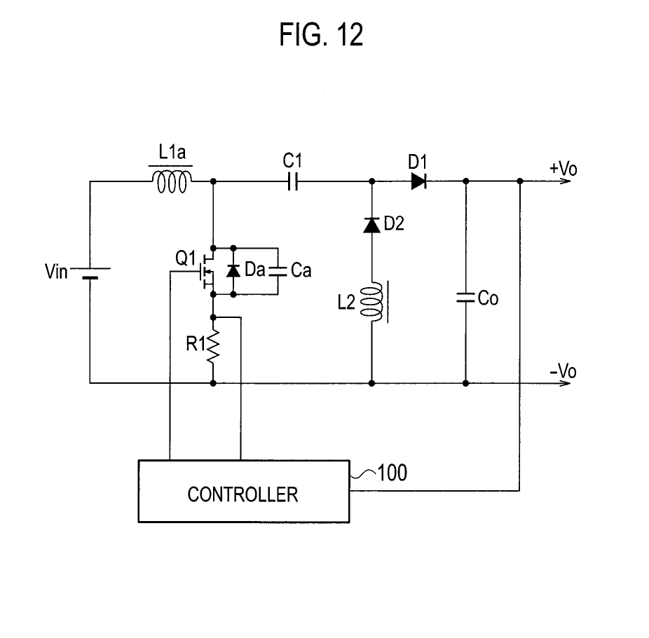

FIG. 12 is a circuit diagram illustrating a switching power source circuit according to Embodiment 7 of the present invention. Compared with the switching power source circuit of the related art illustrated in FIG. 1, the switching power source circuit according to Embodiment 7 additionally employs a diode D2 (corresponding to the “second diode” in the claims). A cathode of the diode D2 is connected to a connection point between a capacitor C1 and a diode D1 and an anode of the diode D2 is connected to a first end of a reactor L2.

According to Embodiment 7, the diode D2 is reversely biased if the capacitor C1 causes a short circuit, thereby preventing a ground fault through a path along Vin, L1a, and L2.

The present invention is not limited to the switching power source circuits of Embodiments 1 to 7. For example, any one of the switching power source circuits illustrated in FIGS. 6, 9, and 11 may have a diode D2 having a cathode connected to a connection point of the capacitor C1 and diode D1 and an anode connected to a first end of the reactor L2 (L1-3). The diode D2 is reversely biased if the capacitor C1 causes a short circuit, thereby preventing a ground fault.

Similarly, the switching power source circuit of FIG. 8 may have a diode D2 having a cathode connected to a connection point of the capacitor C1 and second coil L2-2 and an anode connected to a first end of the first coil L2-1. If the capacitor C1 causes a short circuit, the diode D2 is reversely biased to prevent a ground fault through a route along Vin, L1a, and L2-1.

As mentioned above, the switching power source circuit according to the present invention turns off the first switching element to discharge excitation energy of the first reactor from the first coil to the output capacitor through the second switching element and second capacitor. Although the second capacitor is charged at this time, the energy is also discharged from the second coil, and therefore, the second capacitor is discharged through a route extending along the second coil, second reactor, first capacitor, second capacitor, and second switching element, or through a route extending along the second coil, second reactor, first capacitor, first diode, second capacitor, and second switching element, thereby suppressing the charge voltage of the second capacitor to a low level. This results in applying no voltage exceeding a withstand voltage to the first and second switching elements, realizing zero-volt switching of the first and second switching elements, and improving the efficiency of the switching power source circuit.

The present invention is applicable to DC-DC converters, power factor correction circuits, AC-DC converters, and the like.

This application claims benefit of priority under 35 USC §119 to Japanese Patent Application No. 2011-158944, filed on Jul. 20, 2011, the entire contents of which are incorporated by reference herein.

What is claimed is:

1. A switching power source circuit comprising:
a reactor circuit having first and second reactors connected in series, the first reactor having a first coil and a second coil magnetically coupled with the first coil;
a first series circuit connected between first and second ends of a DC power source and including the first reactor, the second reactor, a first capacitor, a first diode, and an output capacitor;
a first switching element connected between a connection point of the first and second coils and the first end of the DC power source;
a second series circuit including a second switching element and a second capacitor, a first end of the second series circuit connected to a connection point of the first and second coils, and a second end of the second series circuit connected to one of a connection point of the first capacitor and first diode and a connection point of the first diode and output capacitor;
a third reactor connected between a connection point of the first capacitor and first diode and the first end of the DC power source; and
a controller configured to control ON/OFF of the second switching element so that the first switching element carries out zero-volt switching when turned on.

2. The switching power source circuit of claim 1, wherein the third reactor is connected between the connection point of the first capacitor and first diode and the first end of the DC power source through a second diode.

3. The switching power source circuit of claim 1, wherein the first reactor of the reactor circuit and the third reactor are magnetically coupled with each other.

4. A switching power source circuit comprising:
a reactor circuit having first and second reactors connected in series, the first reactor having a first coil whose first end being connected to a first end of a DC power source and a second coil being magnetically coupled with the first coil;
a first series circuit connected between the first and second ends of the DC power source and including a third reactor, a first capacitor, the second coil, the second reactor, a first diode, and an output capacitor;
a first switching element connected between a connection point of the third reactor and first capacitor and the first end of the DC power source;
a second series circuit including a second switching element and a second capacitor, a first end connected to a connection point of the first and second coils, and a second end connected to a connection point of the first diode and output capacitor and
a controller configured to control ON/OFF of the second switching element so that the first switching element carries out zero-volt switching when turned on.

5. The switching power source circuit of claim 4, wherein
the first coil of the first reactor is connected between the connection point of the first capacitor and the second coil of the first reactor and the first end of the DC power source through a second diode.

6. The switching power source circuit of claim 1, wherein
the second reactor is a leakage inductance between the first and second coils of the first reactor.

7. The switching power source circuit of claim 4, wherein
the second reactor is a leakage inductance between the first and second coils of the first reactor.

8. A switching power source circuit comprising:
a first series circuit connected between first and second ends of a DC power source and including a first reactor, a first capacitor, a first diode, and an output capacitor;
a first switching element connected between a connection point of the first reactor and first capacitor and the first end of the DC power source;
a second series circuit connected between a connection point of the first capacitor and first diode and the first end of the DC power source and including a second diode and a second reactor; and
a controller configured to control the first switching element so that the first switching element carries out zero-volt switching when turned on.
